(19) United States
(12) Patent Application Publication
(10) Pub. No.: US 2008/0110726 A1
(43) Pub. Date: May 15, 2008

(54) Drive for a conveyor, in particular baggage conveyor in airports

(75) Inventor: Thomas Helgert, Vohenstrauss (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/903,970

(22) Filed: Sep. 25, 2007

(30) Foreign Application Priority Data
Sep. 29, 2006 (DE) 10 2006 046 751.5

(51) Int. Cl. B65G 23/20

(52) U.S. Cl. 198/832

(57) ABSTRACT

The invention relates to the drive for a conveyor, in particular baggage conveyor having overlapping plate-like carriers which are fastened on an endlessly circulating articulated traction chain. In order for the drive to be of straightforward, functional and effective configuration, the invention proposes a drive mechanism which comprises at least one helically toothed rotationally driven worm which is oriented parallel to the transporting direction and in the manner of a worm gear mechanism, as it is driven in rotation about its longitudinal axis, corresponds with drivers which are provided on the traction chain and engage in a form-fitting manner in the toothing formation of the worm.

### CROSS REFERENCE TO RELATED APPLICATIONS

This application claims priority of German Patent application No. 10 2006 046 751.5 filed Sep. 29, 2006, which is incorporated by reference herein in its entirety.

### FIELD OF INVENTION

The invention relates to a drive for a conveyor, in particular baggage conveyor in airports, in which a multiplicity of overlapping plate-like carriers are guided on an endless movement path for the purpose of transporting items which can be positioned on them, and the carriers are fastened on an articulated traction chain which circulates, likewise endlessly, along the movement path, it being the case that the traction chain allows deflections around hinge pins in at least one plane, and can be driven by a stationary, drive mechanism which, acting on a rectilinear traction-chain portion comprising a plurality of chain links, advances the traction chain in the transporting direction.

### BACKGROUND OF THE INVENTION

Conveyors of the type described in the introduction are usually used in public and in non-public areas of airports, e.g. for transporting items of baggage. Such baggage conveyors are known, in particular, as so-called race tracks at baggage reclaim, i.e. where the passenger, after landing, can retrieve his baggage which has been transported separately. The so-called race tracks are designed as circulating conveyors, that is to say ones which circulate endlessly, and, on account of the curve-negotiating capability necessary, comprise plate-like carriers, usually made of metal, plastic or rubber, which are guided on the endless movement path of the circulating conveyor. The plates are fastened on an endlessly circulating traction chain which, for its part, can be deflected, at least in the horizontal plane, in order that the traction chain and the plate-like carriers, which can be displaced in relation to one another, can follow the curved path of the circulating conveyor. The individual chain links are connected to one another in an articulated manner via vertically oriented pins; if appropriate, the possibility of articulation in the horizontal plane is also provided, for example, if slopes or inclines are to be negotiated.

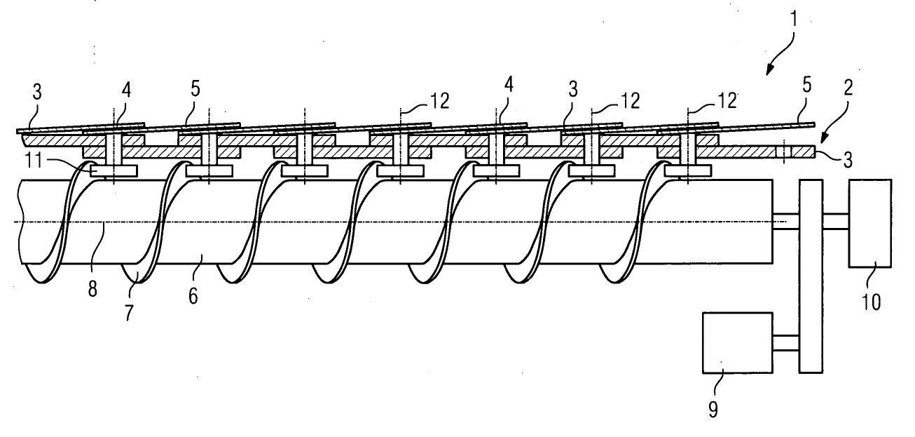

The conveyor with the plate-like carriers is driven endlessly via the traction chain. For this purpose, it is known for the traction chain to be carried along by friction via a stationary drive mechanism, for example in the manner illustrated in drawing FIG. 7 in EP 0 869 086 B1. This figure shows how drive belts which can be positioned against a portion of the traction chain on both sides and, for their part, are driven in an endlessly circulating manner, are used to transmit, via a friction fit, the driving torque of the drive belts to the traction chain, in which case the latter can be moved forward in the transporting direction of the conveyor. The drive belts are arranged on both sides of the traction chain, in which case the latter has the portions which are to be driven clamped in between those portions of the belts which butt against the chain links, the clamping-in force being increased by the provision of spring-loaded contact-pressure rollers. These contact-pressure rollers butt against the rear side of the drive belt and press its front side, which is of non-slip design, against the traction-chain portions.

The drive belts, which are designed as flat rubber belts, have the disadvantage that the starting and stopping of the conveyor necessarily give rise to a considerable amount of flexing, which is increased by the narrow radii of deflection of the drive belt. This results in a very high level of wear, especially as slippage of the drive belt generally cannot always be avoided. In order for it to be possible for the traction chain to be carried along by friction at all, the surface pressure applied to the chain links by the belt has to be appropriately high, in order to allow the moment of inertia to be overcome by the friction fit when the circulating conveyor is fully loaded. This requires, in turn, high-outlay structures, for example the above described spring-loaded contact-pressure rollers for pressing the drive belt onto the traction chain.

### SUMMARY OF INVENTION

In order to avoid these recognized disadvantages, and to provide a straightforward and functionally reliable drive for a conveyor of the generic type, the invention proposes that the drive mechanism comprises at least one helical drive worm which is oriented parallel to the transporting direction and in the manner of a worm gear mechanism, as it is driven in rotation about its longitudinal axis, corresponds with drivers which are provided on the traction chain and engage in a form-fitting manner in the toothing formation of the worm.

In contrast to the traction chain being carried along by friction, as has been conventional hitherto, the invention proposes a kind of worm gear mechanism which allows the traction chain to be carried along in a form-fitting manner by the drive unit. It is thus possible to dispense with the high-outlay contact-pressure means of the known drive belts, and it is no longer necessary for the traction chain to be clamped in between the drive units, as is known in the case of the flat rubber belts. The drive unit is thus very much simplified and therefore more cost-effective and is no longer exposed to the high level of wear which necessitates constant maintenance along with associated stoppages of the installation.

In a preferred embodiment of the invention, it is proposed that the drivers are provided on the hinge pins of the traction chain. A corresponding design of these hinge pins, which are necessary anyway for deflecting the traction chain over curved regions, allows this part of the traction chain to engage in the worm gear mechanism, that is to say behind the circulating toothing formation of the worm.

It is particularly advantageous if, according to a further feature of the invention, provision is made to design the drivers as rollers which are each mounted at the free ends of the hinge pins, the free ends projecting out of the traction chain. For this purpose, the hinge pins themselves are configured, at the same time, as “floating” pins for the rollers of the drivers, each hinge pin of the traction chain being longer than necessary for its articulation function, and the roller being mounted on that part of the hinge pin which projects out of the traction chain. These rollers of all such hinge pins, in turn, engage one after the other, during circulation, behind the helically circulating tooth of the rotationally driven worm and roll on the flank of the tooth as soon as the worm rotates about its longitudinal axis. Since the traction chain is guided in the longitudinal direction, this method of the roller engaging in the worm causes the conveyor to be advanced in its transporting direction; wear to the drivers is avoided by the rollers being mounted for rotation on the hinge pin.

It is particularly advantageous if, according to a further feature of the invention, it is provided that the helically toothed worm is mounted beneath the traction chain, within a rectilinear portion of the movement path. This has the advantage that rather than, as in the prior art, two oppositely located drives which clamp in the traction chain, just one drive has to be provided, and this drive can be mounted very straightforwardly, and in a protected state, on the frame of the conveyor.

If, according to another feature of the invention, it is provided that more than one helically toothed worm engage in the traction chain, this serves to apply an enhanced driving torque for the traction chain, it being possible for the worms to be distributed at different locations of the circulating conveyor.

According to the invention, it is possible for the worms to be driven synchronously by a common drive or else, according to another feature of the invention, each to be provided with a dedicated drive. In the latter case, it is likewise necessary for the two drives, as long as the worms are in engagement with the drivers, to be synchronized.

The solution according to the invention is particularly advantageous if, when use is made of a plurality of worms for driving a traction chain, at least one of the worms can be uncoupled from its drive. If, for example, two driven worms are used, then, in the case of one drive failing, one worm can be uncoupled from its drive in order to allow continued operation of the installation by way of the remaining drive, via the remaining worm.

This can be realized extremely straightforwardly by a freewheel on one of the worms.

According to one proposal of the invention, the drive provided for the worm or the worms is a geared motor with associated frequency converter. The frequency converter makes it possible to use inexpensive standard motors over a wide speed range; this provides a very inexpensive and functionally reliable drive for a conveyor of the generic type which does not have the abovedescribed disadvantages of the drive belt drives of the generic type.

Instead of the geared motor proposed, it is also possible to use known roller motors which are arranged directly in the worm.

### BRIEF DESCRIPTION OF THE DRAWINGS

An exemplary embodiment of the invention is illustrated in the drawing and described hereinbelow.

The single FIGURE of the drawing is roughly schematic and serves only to give an understanding of the functioning. The FIGURE of the drawing illustrates a side view of the conveyor according to the invention.

### DETAILED DESCRIPTION OF INVENTION

The drive of a baggage conveyor is designated overall by 1. The traction chain, which is designated overall by 2, comprises the individual chain links 3, which are connected to one another via hinge pins 4. The hinge pins 4 allow the traction chain to be deflected in the horizontal plane, that is to say perpendicularly to the plane of the drawing. The plate-like carriers are fastened on the traction chain 2, as illustrated schematically at 5, and, overlapping one another, provide an imbricated carrying surface for flight baggage (not illustrated) lying thereon.

The vertically oriented hinge pins 4 are extended downward and serve as a mounting for drivers which are designed as rollers 11 and are mounted for rotation coaxially about the longitudinal axes 12 of the hinge pins 4. Arranged beneath the traction chain 2 is the helically toothed worm 6 according to the invention, the longitudinal axis 8 of which lies parallel to the movement direction of the traction chain 2. The worm is configured as a cylindrical basic body around which the toothing formation 7 winds helically, it being possible for the toothing formation to be designed with one or more starts. The rollers 11 of the drivers project between the individual turns of the toothing formation, in which case, as the worm 6 rotates about the longitudinal axis 8, they are carried along by the flanks of the toothing formation 7, the rollers 11 rolling on the flanks 7. Since the traction chain is guided in the longitudinal movement direction of the conveyor, the force component in the transporting direction of the conveyor, which is transmitted to the rollers 11 by the toothing formation 7, causes the traction chain 2 to move in the same direction. This provides a very straightforward, effective, form-fitting drive for such a traction chain, which merely has to be modified in that the extended hinge pins have to engage correspondingly as drivers in the worm. Of course, it is also possible for the drivers to be of some other configuration and to be formed, for example, directly on the chain links or to be fastened thereon.

The worm can be driven, for example, by the geared motor 9 with the frequency converter 10; however, it is also possible to install a roller motor (not illustrated) in the interior of the worm, coaxially with the longitudinal axis of the latter, and to use this to drive the worm. The mounting of the worm and the drive of the same are otherwise conventional and thus need not be described in detail.

1. A drive for a conveyor, in particular baggage conveyor in airports, in which a multiplicity of overlapping plate-like carriers are guided on an endless movement path for the purpose of transporting items which can be positioned on them, and the carriers are fastened on an articulated traction chain which circulates, it being likewise endlessly, along the movement path, in the case that the traction chain allows deflections around hinge pins in at least one plane, and can be driven by a stationary drive mechanism which, acting on a rectilinear traction-chain portion comprising a plurality of chain links, advances the traction chain in the transporting direction, characterized in that the drive mechanism comprises at least one helically toothed rotationally driven worm (6) which is oriented parallel to the transporting direction and in the manner of a worm gear mechanism, as it is driven in rotation about its longitudinal axis (8), corresponds with drivers (rollers 11) which are provided on the traction chain (2) and engage in a form-fitting manner in the toothing formation (7) of the worm (6).

2. The drive for a conveyor as claimed in claim 1, characterized in that the drivers (rollers 11) are provided on the hinge pins (4) of the traction chain (2).

3. The drive for a conveyor as claimed in claim 2, characterized in that the drivers are designed as rollers (11) which are each mounted at the free ends of the hinge pins (4), the free ends projecting out of the traction chain (2).

4. The drive for a conveyor as claimed in claims 1 to 3, characterized in that the helically toothed worm (6) is mounted beneath the traction chain (2), within a rectilinear portion of the movement path.

5. The drive for a conveyor as claimed in claims 1 to 4, characterized in that more than one helically toothed worm (6) engage in the traction chain (2).

6. The drive for a conveyor as claimed in claim 5, characterized in that the worms (6) can be driven synchronously by a common drive (9).

7. The drive for a conveyor as claimed in claim 5, characterized in that each worm (6) is provided with a dedicated drive (9).

8. The drive for a conveyor as claimed in one of claims 5 to 7, characterized in that at least one of the worms (6) can be uncoupled from its drive (9).

9. The drive for a conveyor as claimed in claim 8, characterized in that at least one worm (6) is provided with a freewheel.

10. The drive for a conveyor as claimed in claims 1 to 9, characterized in that the drive (9) of the worm (6) is a geared motor (9) with associated frequency converter (10).
